(19) United States
(12) Patent Application Publication
(10) Pub. No.: US 2026/0316781 A1
(43) Pub. Date: Oct. 15, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventors: Tomotaka Teramachi, Tokyo (JP); Akito Kokubo, Tokyo (JP)

(21) Appl. No.: 19/547,730

(22) Filed: Feb. 24, 2026

(30) Foreign Application Priority Data
Feb. 28, 2025 (JP) 2025-031698

(51) Int. Cl. B60W 50/14; B60W 30/18

(52) U.S. Cl. CPC B60W 50/14; B60W 30/18163; B60W 2540/215; B60W 2540/223; B60W 2552/10

(57) ABSTRACT

A travel control device includes an output interface, an input interface, a lane change control unit configured to cause transition to an activated state or a non-activated state to occur in response to an operation of the input interface by the occupant, and execute a lane change in the activated state, and a recommendation unit configured to start outputting, via the output interface, a recommendation of a lane change to the occupant when the vehicle has reached a predetermined point upstream of a route guidance point in the activated state, wherein the lane change control unit executes the lane change when an operation for approving the recommendation is input to the input interface after the output of the recommendation has been started, and the recommendation unit does not start outputting the recommendation when the transition from the non-activated state to the activated state has occurred after the vehicle passes through the predetermined point.

### CROSS-REFERENCE TO RELATED APPLICATION

This application is based upon and claims the benefit of priority from Japanese Patent Application No. 2025-031698, filed Feb. 28, 2025, the entire content of which is incorporated herein by reference.

### BACKGROUND

### Field of the Invention

The present invention relates to a traveling control device, a traveling control method, and a storage medium.

### Description of Related Art

In recent years, initiatives to provide access to sustainable transportation systems that also give consideration to people who are in a vulnerable position among traffic participants have been intensifying. To realize this, efforts are being focused on research and development to further improve the safety or convenience of traffic through research and development regarding automated driving technology. For example, a technology for changing an intensity of a notification of a lane change according to a type of lane change when auto lane changing to a branching road is performed is known (see, for example, Japanese Unexamined Patent Application, First Publication No. 2023-003663).

### SUMMARY

Assuming that a lane change is notified while a system is operating, when a timing at which the system is activated is delayed, a timing at which the lane change is notified may also be delayed. Further, if the lane change is notified when a vehicle is approaching a limit position at which lane change control can be performed, the system side may give up the lane change immediately after the notification, and as a result, there is concern that an occupant may feel discomfort.

An object of the present invention is to reduce a feeling of discomfort given to an occupant when a lane change is executed in order to solve the above-described problem. Another object of the present invention is to contribute to the development of sustainable transportation systems.

A travel control device, a travel control method, and a storage medium according to the present invention adopt the following configuration.
(1) A first aspect of the present invention is a travel control device including: an output interface configured to output information; an input interface operated by an occupant of a vehicle; a lane change control unit configured to cause transition to an activated state or a non-activated state to occur in response to an operation of the input interface by the occupant, and execute a lane change in the activated state; and a recommendation unit configured to start outputting, via the output interface, a recommendation of a lane change to the occupant when the vehicle has reached a predetermined point upstream of a route guidance point in the activated state, wherein the lane change control unit executes the lane change when an approval operation that is an operation by the occupant for approving the recommendation is input to the input interface after the output of the recommendation has been started, and the recommendation unit does not start outputting the recommendation when the transition from the non-activated state to the activated state has occurred after the vehicle passes through the predetermined point.
(2) A second aspect of the present invention is the traveling control device according to the first aspect, wherein the recommendation unit ends outputting the recommendation when the vehicle has reached a recommendation end point that is a point at which the output of the recommendation is ended without the approval operation being input to the input interface after the output of the recommendation has been started, the recommendation end point being beyond the predetermined point and upstream of the route guidance point; and does not start outputting the recommendation when the transition from the non-activated state to the activated state has occurred in a period from the vehicle passing through the predetermined point to the vehicle reaching the recommendation end point.
(3) A third aspect of the present invention is the traveling control device according to the first aspect, wherein the recommendation unit starts outputting the recommendation when the transition from the non-activated state to the activated state has occurred in a period from the vehicle passing through the predetermined point to the vehicle reaching a recommendation start limit point, the recommendation start limit point being a limit point at which output of the recommendation is started, being beyond the predetermined point, and being upstream of the route guidance point; and does not start outputting the recommendation when the transition from the non-activated state to the activated state has occurred after the vehicle has reached the recommendation start limit point.
(4) A fourth aspect of the present invention is the traveling control device according to the second aspect, wherein the recommendation unit starts outputting the recommendation when the transition from the non-activated state to the activated state has occurred in a period from the vehicle passing through the predetermined point to the vehicle reaching a recommendation start limit point, the recommendation start limit point being a limit point at which output of the recommendation is started, being beyond the predetermined point, and being upstream of the recommendation end point; and does not start outputting the recommendation when the transition from the non-activated state to the activated state has occurred after the vehicle has reached the recommendation start limit point.
(5) A fifth aspect of the present invention is the traveling control device according to the first aspect, wherein the recommendation unit does not start outputting the recommendation when the transition from the non-activated state to the activated state has occurred after the vehicle passes through the predetermined point in a case in which the vehicle is traveling in a first lane adjacent to a target lane at the route guidance point; starts outputting the recommendation when the transition from the non-activated state to the activated state has occurred, in a period from the vehicle passing through the predetermined point to the vehicle reaching a recommendation start limit point, the recommendation start limit point being a limit point at which output of the recommendation is started, being beyond the predetermined point, and being upstream of the route guidance point, in a case in which the vehicle is traveling in a second lane that is not adjacent to the target lane and is two or more lanes away at the route guidance point; and does not start outputting the recommendation when the transition from the non-activated state to the activated state has occurred after the vehicle passes through the recommendation start limit point in a case in which the vehicle is traveling in the second lane.
(6) A sixth aspect of the present invention is the traveling control device according to the fifth aspect, wherein the predetermined point is set as a different point between a case in which the vehicle is traveling in the first lane adjacent to the target lane at the route guidance point and a case in which the vehicle is traveling in the second lane that is not adjacent to the target lane and is two or more lanes away at the route guidance point, and a second predetermined point that is the predetermined point set in the case in which the vehicle is traveling in the second lane is farther from the route guidance point than a first predetermined point that is the predetermined point set in the case in which the vehicle is traveling in the first lane.
(7) A seventh aspect of the present invention is the traveling control device according to the fifth aspect, wherein the recommendation unit ends outputting the recommendation when the vehicle has reached a recommendation end point that is a point at which the output of the recommendation is ended without the approval operation being input to the input interface after the output of the recommendation has been started, the recommendation end point being beyond the predetermined point and upstream of the route guidance point; and does not start outputting the recommendation when the transition from the non-activated state to the activated state has occurred in a period from the vehicle passing through the predetermined point to the vehicle reaching the recommendation end point.
(8) An eighth aspect of the present invention is the traveling control device according to the fifth aspect, wherein the recommendation unit starts outputting the recommendation when the transition from the non-activated state to the activated state has occurred in a period from the vehicle passing through the predetermined point to the vehicle reaching the recommendation start limit point; and does not start outputting the recommendation when the transition from the non-activated state to the activated state has occurred after the vehicle has reached the recommendation start limit point.
(9) A ninth aspect of the present invention is the traveling control device according to the third aspect, wherein the lane change executed when the approval operation is input to the input interface includes a first lane change requiring grasping of a steering wheel by the occupant and a second lane change not requiring grasping of the steering wheel by the occupant, and the recommendation start limit point is set as a different point between a case in which the first lane change is executed and a case in which the second lane change is executed.
(10) A tenth aspect of the present invention is a travel control method using a computer mounted on a vehicle including an output interface configured to output information and an input interface operated by an occupant of the vehicle, the travel control method including: causing transition to an activated state or a non-activated state to occur in response to an operation of the input interface by the occupant, and executing a lane change in the activated state; starting outputting, via the output interface, a recommendation of a lane change to the occupant when the vehicle has reached a predetermined point upstream of a route guidance point in the activated state, executing the lane change when an approval operation that is an operation by the occupant for approving the recommendation is input to the input interface after the output of the recommendation has been started; and not starting outputting the recommendation when the transition from the non-activated state to the activated state has occurred after the vehicle passes through the predetermined point.
(11) An eleventh aspect of the present invention is a non-transitory storage medium storing a program executed by a computer mounted on a vehicle including an output interface configured to output information and an input interface operated by an occupant of the vehicle, the program including: causing transition to an activated state or a non-activated state to occur in response to an operation of the input interface by the occupant, and executing a lane change in the activated state; starting outputting, via the output interface, a recommendation of a lane change to the occupant when the vehicle has reached a predetermined point upstream of a route guidance point in the activated state, executing the lane change when an approval operation that is an operation by the occupant for approving the recommendation is input to the input interface after the output of the recommendation has been started; and not starting outputting the recommendation when the transition from the non-activated state to the activated state has occurred after the vehicle passes through the predetermined point.

According to the above aspects, it is possible to reduce a feeling of discomfort given to the occupant when the lane change is executed.

### BRIEF DESCRIPTION OF THE DRAWINGS

FIG. 1 is a configuration diagram of a vehicle system using a travel control device according to an embodiment.

FIG. 2 is a schematic diagram illustrating a state inside a host vehicle.

FIG. 3 is a functional configuration diagram of a first control unit, a second control unit, a third control unit, and a storage unit.

FIG. 4 is a diagram illustrating a scene in which the host vehicle is caused to perform a lane change.

FIG. 5 is a diagram illustrating a scene in which the host vehicle is caused to perform a lane change.

FIG. 6 is a diagram illustrating a scene in which the host vehicle is caused to perform a lane change.

FIG. 7 is a diagram illustrating an example of display of strong recommendation.

FIG. 8 is a diagram illustrating an example of classification of scenes in which the strong recommendation is output.

FIG. 9 is a diagram illustrating an example of an image output to a MID as the strong recommendation in each scene.

FIG. 10 is a diagram illustrating an example of an image output to the MID as the strong recommendation in each scene.

FIG. 11 is a diagram illustrating an example of an image output to the MID as the strong recommendation in each scene.

FIG. 12 is a diagram illustrating an example of an image output to the MID as the strong recommendation in each scene.

FIG. 13 is a diagram schematically illustrating an example of a scene in which the strong recommendation is output.

FIG. 14 is a diagram schematically illustrating an example of a scene in which weak recommendation is output.

FIG. 15 is a diagram illustrating a display example of the weak recommendation.

FIG. 16 is a diagram showing an example of driving control of a host vehicle and display on a first display.

FIG. 17 is a diagram showing an example of a screen of the first display when the host vehicle has reached a recommendation start point in an activated state.

FIG. 18 is a diagram showing an example of a screen of the first display when an occupant approves a lane change.

FIG. 19 is a diagram showing an example of a screen of the first display in a hands-on state.

FIG. 20 is a flowchart showing an example of a flow of a series of processes in the automated driving control device according to the embodiment.

FIG. 21 is a diagram showing another example of driving control of the host vehicle and display on the first display.

### DESCRIPTION OF EMBODIMENTS

Hereinafter, embodiments of a travel control device, a travel control method, and a storage medium of the present invention will be described with reference to the drawings. The vehicle control device of the embodiment is applicable, for example, to an automated driving vehicle. Automated driving refers, for example, to controlling the driving of a vehicle by controlling one or both of speed and steering of the vehicle.

Driving control of the vehicle described above includes various types of driving control such as adaptive cruise control system (ACC), traffic jam pilot (TJP), auto lane changing (ALC), collision mitigation brake system (CMBS), and lane keeping assistance system (LKAS). Driving of the automated driving vehicle may also be controlled by manual driving of an occupant (driver). Hereinafter, a case in which a left-hand traffic regulation applies will be described, but when a right-hand traffic regulation applies, left and right may be read in reverse.

### Overall Configuration

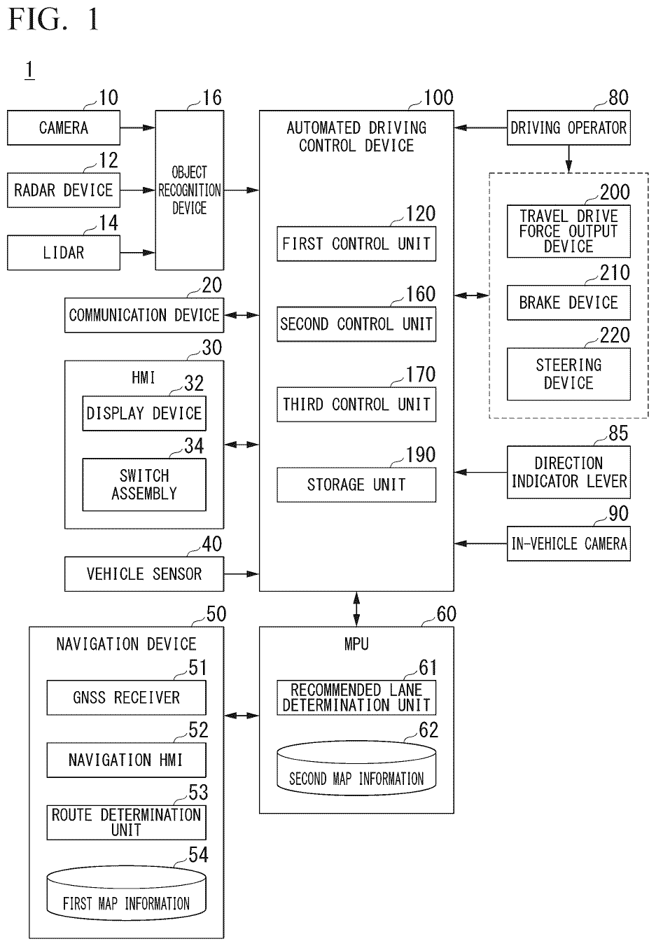

FIG. 1 is a configuration diagram of a vehicle system 1 using a travel control device according to an embodiment. A vehicle on which the vehicle system 1 is mounted (hereinafter referred to as a “host vehicle M”) is, for example, a two-wheeled, three-wheeled, or four-wheeled vehicle, and a drive source thereof includes an internal combustion engine such as a diesel engine or a gasoline engine, an electric motor, or a combination thereof. The electric motor operates using electric power generated by a generator coupled to the internal combustion engine, or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, vehicle sensors 40, a navigation device 50, a map positioning unit (MPU) 60, a driving operator 80, a direction indicator lever 85, an in-vehicle camera 90, an automated driving control device 100, a travel drive force output device 200, a brake device 210, and a steering device 220. These devices or units are interconnected by a multiplex communication line such as a controller area network (CAN) communication line, a serial communication line, or a wireless communication network, or the like. The configuration illustrated in FIG. 1 is merely an example, part of the configuration may be omitted, or additional configurations may be added. The automated driving control device 100 is an example of the “travel control device.”

The camera 10 is, for example, a digital camera that uses a solid-state imaging element such as a charge coupled device (CCD) or a complementary metal oxide semiconductor (CMOS). The camera 10 is attached at any location on the host vehicle M. When the camera 10 images the front of the host vehicle M, the camera 10 may be attached on an upper part of a front windshield, on a back surface of the room mirror, or the like. When the camera 10 images the rear of the host vehicle M, the camera 10 may be attached on an upper part of the rear windshield, or the like. When the camera 10 images a right or left side of the host vehicle M, the camera 10 may be attached to, for example, a right or left side surface of a vehicle body or door mirror. The camera 10 periodically and repeatedly images the surroundings of the host vehicle M. The camera 10 may be a stereo camera.

The radar device 12 radiates radio waves such as millimeter waves to the surroundings of the host vehicle M and detects radio waves (reflected waves) reflected by an object, thereby detecting at least a position (distance and direction) of the object. The radar device 12 may be attached at any location on the host vehicle M. The radar device 12 may detect the position and speed of the object using a frequency modulated continuous wave (FM-CW) scheme.

The LIDAR 14 irradiates light to the surroundings of the host vehicle M and measures scattered light of the irradiated light. The LIDAR 14 detects a distance to a target based on time from emission to reception. The irradiated light may be, for example, pulsed laser light. The LIDAR 14 may be attached at any location on the host vehicle M.

The object recognition device 16 performs sensor-fusion processing on detection results obtained by some or all of the camera 10, the radar device 12, and the LIDAR 14, and recognizes, for example, the position, type, and speed of the object. The object recognition device 16 outputs the recognition results to the automated driving control device 100. The object recognition device 16 may output detection results of the camera 10, the radar device 12, and the LIDAR 14 directly to the automated driving control device 100. The object recognition device 16 may be omitted from the vehicle system 1.

The communication device 20 uses, for example, a cellular network, a Wi-Fi network, Bluetooth (registered trademark; hereinafter omitted), dedicated short range communication (DSRC), or the like to communicate with other vehicles present around the host vehicle M or communicate with various server devices via a wireless base station.

The HMI 30 presents various kinds of information to occupants of the host vehicle M and accepts input operations from the occupants. For example, the HMI 30 includes a display device 32 and a switch assembly 34. The display device 32 includes, for example, a first display 32A and a second display 32B. The switch assembly 34 includes, for example, an active lane change recommendation (ALCR) switch 34A. The HMI 30 may further include a speaker, buzzer, touch panel, microphone, or the like.

The display device 32 (the first display 32A and second display 32B) is an example of an “output interface.” The switch assembly 34 (an ALCR switch 34A) is an example of an “input interface.”

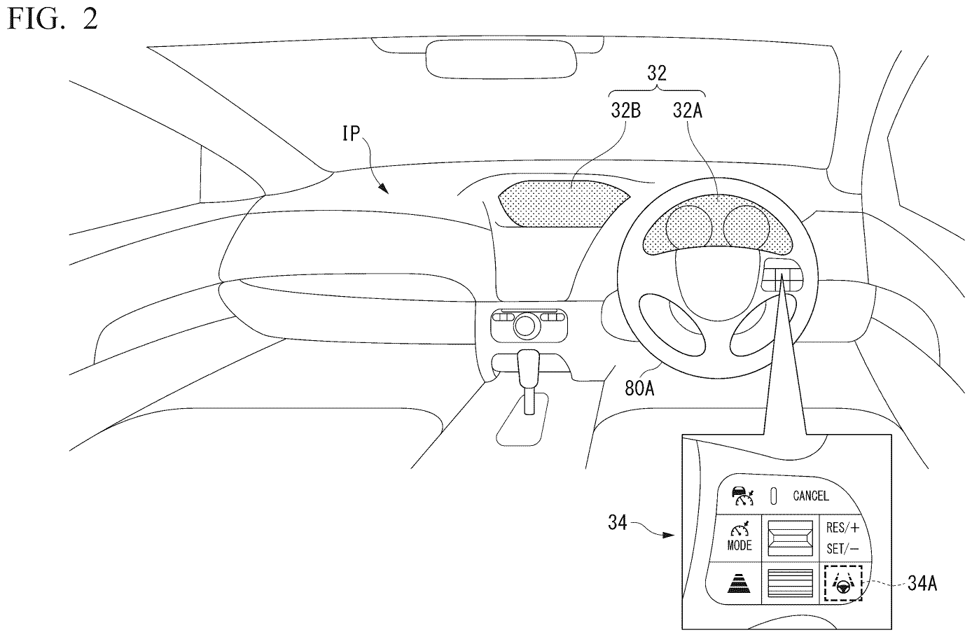

FIG. 2 is a diagram schematically illustrating a state inside the host vehicle M. For example, the first display 32A is provided near the front of a driver's seat (a seat closest to a steering wheel) on an instrument panel IP, and is installed at a position that the occupant can visually recognize through a gap in the steering wheel or over the steering wheel.

The first display 32A is, for example, a liquid crystal display (LCD) or an organic electro luminescence (EL) display device. The first display 32A displays, as an image, information necessary for travel during manual driving or driving assistance of the host vehicle M. The information necessary for the travel of the host vehicle M during manual driving includes, for example, speed, engine speed, remaining fuel, radiator water temperature, travel distance, remaining battery level, and other information. The information necessary for the travel of the host vehicle M during driving assistance includes, for example, a future trajectory of the host vehicle M (a target trajectory to be described later), whether a lane change will occur, a lane that is a lane change destination, and information on recognized lanes (lane markings), other vehicles. Further, the information necessary for the travel of the host vehicle M during driving assistance may include some or all of the information necessary for the travel of the host vehicle M during manual driving.

The second display 32B is installed, for example, near a center of the instrument panel IP. The second display 32B is, for example, an LCD or organic EL display device, like the first display 32A. The second display 32B displays, for example, a navigation results of the navigation device 50 as an image. The second display 32B may display television programs, play DVDs, or display content such as downloaded movies.

The switch assembly 34 is, for example, attached to the steering wheel. The ALCR switch 34A included in the switch assembly 34 is a switch operated by the occupant for transition of a driving mode of the host vehicle M to a second automated driving mode, which will be described later. Under the second automated driving mode, the ALC is executed in addition to the ACC or the LKAS. That is, the ALCR switch 34A is operated for transition from a state in which the ALC cannot be executed to a state in which the ALC can be executed. Hereinafter, the state in which the ALC cannot be executed will be referred to as a non-activated state, and the state in which the ALC can be executed will be referred to as an activated state.

Further, in the activated state, the ALCR switch 34A is also operated by the occupant to determine whether to accept or reject an active ALC recommended by the automated driving control device 100. The ALCR switch 34A may be a push switch operable only in one direction. Details of a lane change recommendation will be described later. Operating the ALCR switch 34A is an example of an “approval operation.”

The vehicle sensor 40 includes a vehicle-speed sensor that detects the speed of the host vehicle M, an acceleration sensor that detects acceleration, a yaw-rate sensor that detects an angular velocity around a vertical axis, and a direction sensor that detects an orientation of the host vehicle M.

The navigation device 50 includes, for example, a global navigation satellite system (GNSS) receiver 51, a navigation human machine interface (HMI) 52, and a route determination unit 53. The navigation device 50 stores first map information 54 in a 14 storage device such as a hard disk drive (HDD) or a flash memory.

The GNSS receiver 51 determines the position of the host vehicle M based on signals received from GNSS satellites. The position of the host vehicle M may also be determined or supplemented by an inertial navigation system (INS) using an output of the vehicle sensor 40.

The navigation HMI 52 includes a display device, a speaker, a touch panel, keys, and the like. Part or all of the navigation HMI 52 may be shared with the HMI 30 described above. For example, instead of or in addition to inputting a destination of the host vehicle M via the HMI 30, the occupant may input the destination via the navigation HMI 52.

The route determination unit 53 determines a route (hereinafter referred to as a “map route”) from a position of the host vehicle M identified by the GNSS receiver 51 (or any input position) to the destination entered by the occupant using the HMI 30 or the navigation HMI 52, with reference to the first map information 54.

The first map information 54 is information in which a road geometry is represented by links indicating roads and nodes connected by the links. The first map information 54 may include, for example, road curvature or point of interest (POI) information. The map route is output to the MPU 60.

The navigation device 50 may provide route guidance using the navigation HMI 52 based on the map route. The navigation device 50 may also be realized using functions of a terminal device such as a smartphone or tablet owned by the occupant.

The navigation device 50 may transmit a current location and destination to a navigation server via the communication device 20 and acquire a route equivalent to the map route from the navigation server.

The MPU 60 includes, for example, a recommended-lane determination unit 61 and stores second map information 62 in a storage device such as an HDD or flash memory. The recommended-lane determination unit 61 divides the map route provided by the navigation device 50 into a plurality of blocks (for example, every 100 meters in a direction in which the vehicle travels) and determines a recommended lane for each block by referring to the second map information 62. The recommended-lane determination unit 61 determines, for example, which lane number from the left the vehicle travels in. When there is a branch location on the map route, the recommended-lane determination unit 61 determines a recommended lane that allows the host vehicle M to travel on a reasonable route toward a branch destination.

The second map information 62 is higher accuracy map information than the first map information 54. The second map information 62 includes, for example, information on a center of a lane or a boundary of the lane. Further, the second map information 62 may include road information, traffic regulation information, address information (address/postal code), facility information, telephone number information, and the like. The second map information 62 may be updated as needed through communication of the communication device 20 with other devices.

The driving operator 80 includes, for example, an accelerator pedal, a brake pedal, a shift lever, a steering wheel, an irregular steering wheel, a joystick, and another operator. Sensors that detect an amount of operation or whether the operation has occurred are attached to the driving operator 80, and detection results thereof are output to the automated driving control device 100 or to some or all of the travel drive force output device 200, the brake device 210, and the steering device 220.

For example, a sensor attached to the steering wheel (hereinafter, a steering sensor) detects subtle electric current generated when the occupant touches the steering wheel (for example, a change in capacitance). The steering sensor may also detect steering torque generated around the steering wheel's rotational axis (shaft). When the steering sensor detects electric current or steering torque, the steering sensor outputs a signal indicating the detection result to the automated driving control device 100.

The direction indicator lever 85 (also referred to as a stalk or a switch), when operated by an occupant, turns on lamps attached to front and rear of the host vehicle M. Further, the direction indicator lever 85 is also operated to instruct a lane change of the host vehicle M. Operating the direction indicator lever 85 to instruct a lane change is also referred to as a one-touch function. Hereinafter, operating the direction indicator lever 85 to instruct a lane change will be referred to as a “lane change instruction operation.”

A lane change instruction may be made by inputting voice to a microphone in addition to or instead of operating the direction indicator lever 85, or may be made by operating another switch or button.

The in-vehicle camera 90 is a camera that images a cabin of the host vehicle M. The in-vehicle camera 90 is, for example, a digital camera that uses a solid-state imaging device such as a CCD or CMOS. When the in-vehicle camera 90 images the cabin of the host vehicle M, the in-vehicle camera 90 outputs image data to the automated driving control device 100.

The automated driving control device 100 includes, for example, a first control unit 120, a second control unit 160, a third control unit 170, and a storage unit 190.

Each of the first control unit 120, the second control unit 160, and the third control unit 170 is realized, for example, by a hardware processor such as a central processing unit (CPU) or a graphics processing unit (GPU) executing a program (software). Some or all of these components may be realized by hardware (including circuitry), such as large scale integration (LSI), an application specific integrated circuit (ASIC), a field-programmable gate array (FPGA), or a system on chip (SOC), or may be realized by cooperation between software and hardware. The program may be stored in advance in a storage device of the automated driving control device 100, such as a hard disk drive (HDD) or flash memory (a storage device including a non-transitory storage medium), or may be stored in a removable storage medium such as a digital versatile disc (DVD) or compact disc read-only memory (CD-ROM) and installed in the HDD or flash memory of the automated driving control device 100 by the storage medium (non-transitory storage medium) mounted in a drive device.

The storage unit 190 is realized by various storage devices described above. The storage unit 190 is realized, for example, by an HDD, flash memory, electrically erasable programmable read-only memory (EEPROM), read only memory (ROM), or random access memory (RAM). The storage unit 190 stores, for example, programs (instructions) that are read out and executed by a processor.

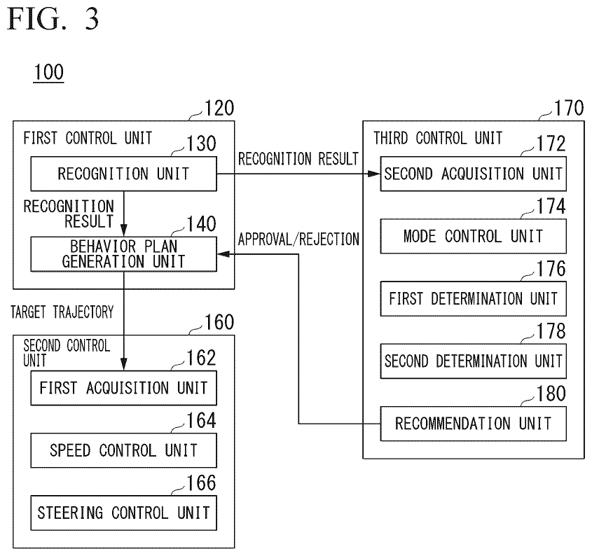

FIG. 3 is a functional block diagram of the first control unit 120, the second control unit 160, the third control unit 170, and the storage unit 190 according to a first embodiment. The first control unit 120 includes, for example, a recognition unit 130 and a behavior plan generation unit 140.

The first control unit 120 realizes, for example, functions using artificial intelligence (AI) and functions based on a predetermined model in parallel. For example, a function of “recognizing an intersection” may be realized by performing, in parallel, recognition of the intersection using deep learning or the like and recognition based on predetermined conditions (there are, for example, signals and road markings that allow pattern matching), scoring both, and performing comprehensive evaluation. This ensures the reliability of automated driving.

The recognition unit 130 recognizes a surrounding situation or environment of the host vehicle M. For example, the recognition unit 130 recognizes objects present around the host vehicle M based on information input from the camera 10, the radar device 12, and the LIDAR 14 via the object recognition device 16. The objects recognized by the recognition unit 130 include, for example, bicycles, motorcycles, four-wheeled vehicles, pedestrians, road signs, road markings, lane markings, utility poles, guardrails, and fallen objects. Further, the recognition unit 130 recognizes states such as a position, speed, and acceleration of the object. The position of the object is recognized, for example, as a position on a relative coordinate system with a representative point of the host vehicle M (such as a center of gravity or a drive shaft center) as an origin (that is, a relative position with respect to the host vehicle M) and is used for control. The position of the object may be represented by a representative point such as a center of gravity or corner of the object, or may be represented by a represented region. The “state” of the object may include acceleration, jerk, or “behavioral state” (for example, whether the object is changing lanes or is about to change lanes) of the object.

Further, the recognition unit 130 recognizes, for example, the lane in which the host vehicle M is traveling (hereinafter, a host lane) and adjacent lanes adjacent to the host lane. For example, the recognition unit 130 recognizes the host lane and adjacent lanes by comparing a pattern (for example, an arrangement of solid lines and broken lines) of a road lane marking obtained from the second map information 62 with a pattern of a road lane marking around the host vehicle M recognized from an image captured by the camera 10.

Further, the recognition unit 130 may recognize lanes such as the host lane or adjacent lanes by recognizing not only road lane markings but also a travel path boundary (road boundary) including road lane markings, shoulders, curbs, medians, guardrails, and the like. In this recognition, a position of the host vehicle M acquired from the navigation device 50 or processing results by the INS may be taken into account. The recognition unit 130 may also recognize stop lines, obstacles, red signals, tollgates, and other road events.

When the recognition unit 130 recognizes the host lane, the recognition unit 130 recognizes a relative position or posture of the host vehicle M with respect to the host lane. For example, the recognition unit 130 may recognize a deviation of a reference point of the host vehicle M from a center of the lane, and an angle formed with respect to a line connecting centers of the lane in a direction in which the host vehicle M travels, as a relative position and posture of the host vehicle M with respect to the host lane. Alternatively, the recognition unit 130 may recognize, for example, a position of the reference point of the host vehicle M with respect to either side edge of the host lane (the road lane marking or the road boundary) as the relative position of the host vehicle M with respect to the host lane.

When the host vehicle M is under automated driving on a route in which a recommended lane has been determined, the behavior plan generation unit 140 determines a driving mode of the automated driving. Hereinafter, information defining the driving mode of automated driving will be referred to as an event.

Events include, for example, a constant-speed driving event, a following driving event, a lane change event, a branching event, a merging event, and a takeover event. The constant-speed driving event is a driving mode in which the host vehicle M is caused to travel in the same lane at a constant speed. The following driving event is a driving mode in which the host vehicle M is caused to follow another vehicle (hereinafter referred to as a preceding vehicle) that is present within a predetermined distance (for example, within 100 meters) in front of the host vehicle M in the host lane and is closest to the host vehicle M.

“To follow” may refer to a driving mode in which an inter-vehicle distance (relative distance) between the host vehicle M and the preceding vehicle is maintained constant, or a driving mode in which the host vehicle M is caused to travel in a center of the host lane, in addition to the inter-vehicle distance between the host vehicle M and the preceding vehicle being maintained constant.

The lane change event is a driving mode in which the host vehicle M is caused to change lanes from the host lane to an adjacent lane. The branching event is a driving mode in which, at a branch point in a road, the host vehicle M is caused to branch into a lane on the destination side. The merging event is a driving mode in which, at a merging point, the host vehicle M is caused to merge into a main lane. The takeover event is a driving mode in which automated driving is terminated and switched to manual driving.

Further, events may include, for example, an overtaking event or an avoidance event. The overtaking event is a driving mode in which the host vehicle M is first caused to change lanes to an adjacent lane to overtake a preceding vehicle in the adjacent lane and then caused to change lanes back to the original lane. The avoidance event is a driving mode in which the host vehicle M is caused to perform at least one of braking and steering in order to avoid an obstacle present in front of the host vehicle M.

Further, the behavior plan generation unit 140 may also change an event already determined for a current section to another event or determine a new event for the current section according to the surrounding situation recognized by the recognition unit 130 during the travel of the host vehicle M.

For example, when the occupant operates the direction indicator lever 85 to signal a left turn, the behavior plan generation unit 140 determines a lane change event in which the host vehicle M is caused to change lanes to an adjacent lane on the left side as viewed from the host vehicle M. Further, for example, when the occupant operates the direction indicator lever 85 to signal a right turn, the behavior plan generation unit 140 determines a lane change event in which the host vehicle M is caused to change lanes to an adjacent lane on the right side as viewed from the host vehicle M.

The behavior plan generation unit 140 generates a future target trajectory for automatically (that is, without depending on the driver's operation) causing the host vehicle M to travel in the travel mode defined by the event, in principle, so that the host vehicle M travels on the recommended lane determined by the recommended-lane determination unit 61 and the host vehicle M responds to the surrounding situation while traveling on the recommended lane. The target trajectory includes, for example, a position element defining a future position of the host vehicle M and a speed element defining, for example, a future speed of the host vehicle M.

For example, the behavior plan generation unit 140 determines, as the position element of the target trajectory, a plurality of points (trajectory points) that the host vehicle M should sequentially reach. The trajectory point is a point that the host vehicle M should reach for each predetermined travel distance (for example, several [m]). The predetermined travel distance may be calculated, for example, based on a road-following distance when the vehicle travels along a route.

Further, the behavior plan generation unit 140 determines, as the speed element of the target trajectory, a target speed and a target acceleration for each predetermined sampling time (for example, on the order of zero point several seconds). Further, each trajectory point may be a position that the host vehicle M should reach at a sampling timing corresponding to each predetermined sampling time. In this case, the target speed and target acceleration are determined by the sampling time and an interval between the trajectory points. The behavior plan generation unit 140 outputs information indicating the generated target trajectory to the second control unit 160.

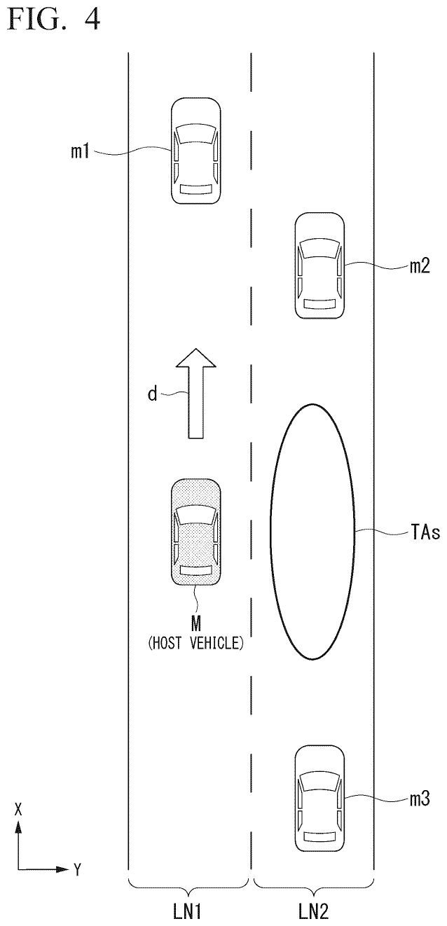

Hereinafter, a scene in which the host vehicle M travels through a section where a lane change event is planned, that is, a scene in which the host vehicle M is caused to perform a lane change will be described by way of example. FIGS. 4 to 6 are diagrams illustrating scenes in which the host vehicle M is caused to perform a lane change. In the figures, LN1 represents a host lane, and LN2 represents an adjacent lane adjacent to the host lane. Further, X represents a direction in which road extends or the direction in which the host vehicle M travels, and Y represents a vehicle width direction orthogonal to the X direction.

When the event of the current section is a lane change event, the behavior plan generation unit 140 selects two other vehicles from among a plurality of other vehicles traveling on an adjacent lane LN2, and sets a lane change target position TAs between the two selected other vehicles. The lane change target position TAs is a position of the lane change destination, which is a target, and is a relative position between the host vehicle M and the other vehicles m2 and m3. In the illustrated example, since the other vehicles m2 and m3 are traveling on the adjacent lane, the behavior plan generation unit 140 sets the lane change target position TAs between the other vehicles m2 and m3. When only one other vehicle is present on the adjacent lane LN2, the behavior plan generation unit 140 may set the lane change target position TAs at an arbitrary position in front of or behind the other vehicle. When no other vehicle is present on the adjacent lane LN2, the behavior plan generation unit 140 may set the lane change target position TAs at an arbitrary position on the adjacent lane LN2. Hereinafter, the other vehicle (m2 in the illustrated example) traveling immediately ahead of the lane change target position TAs on the adjacent lane is referred to as a forward reference vehicle mB, and the other vehicle (in the illustrated example, m3) traveling immediately behind the lane change target position TAs on the adjacent lane is referred to as a rear reference vehicle mC.

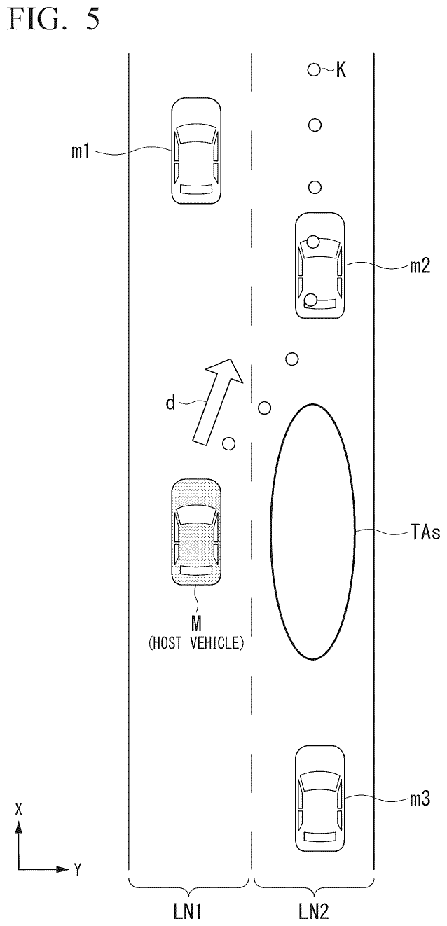

After the behavior plan generation unit 140 sets the lane change target position TAs, the behavior plan generation unit 140 generates a plurality of candidate target trajectories in which the host vehicle M is caused to perform the lane change. In the example of FIG. 5, the behavior plan generation unit 140 assumes that another vehicle m1 which is a preceding vehicle mA, another vehicle m2 which is the forward reference vehicle mB, and another vehicle m3 which is the rear reference vehicle mC travel according to predetermined speed models, and generates the plurality of candidate target trajectories such that the host vehicle M is present at the lane change target position TAs between the forward reference vehicle mB and the rear reference vehicle mC at a certain future time, without interfering with the preceding vehicle mA, based on the speed models of the three vehicles and the speed of the host vehicle M.

For example, the behavior plan generation unit 140 smoothly connects, using a polynomial curve such as a spline curve, from a current position of the host vehicle M to a position of the forward reference vehicle mB at a certain future time, or to a center of a lane that is a lane change destination and an end point of the lane change, and arranges a predetermined number of trajectory points K at equal or unequal intervals on the curve. In this case, the behavior plan generation unit 140 generates the plurality of candidate target trajectories so that at least one of the trajectory points K is arranged within the lane change target position TAs.

The behavior plan generation unit 140 selects an optimal target trajectory from among the plurality of candidate target trajectories that have been generated. The optimal target trajectory is, for example, a target trajectory in which, when the host vehicle M is caused to travel based on the target trajectory, a yaw rate predicted to occur is less than a threshold, and the speed of the host vehicle M is within a predetermined speed range. The threshold of the yaw rate is set, for example, to a yaw rate at which an excessive load (that is, a case in which the acceleration in the vehicle width direction becomes equal to or greater than the threshold) is not applied to the occupant when a lane change is performed. Further, the predetermined speed range is set, for example, to a speed range of approximately 70 to 110 [km/h].

When the behavior plan generation unit 140 sets the lane change target position TAs and generates a target trajectory in which the host vehicle M is caused to perform a lane change to the lane change target position TAs, the behavior plan generation unit 140 determines whether the lane change to the lane change target position TAs (that is, between the forward reference vehicle mB and the rear reference vehicle mC) is possible.

For example, the behavior plan generation unit 140 sets, on the adjacent lane LN2, a prohibited region RA in which the presence of other vehicles is prohibited, and when no part of the other vehicle is present in the prohibited region RA and a time to collision (TTC) between the host vehicle M and the forward reference vehicle mB and a TTC between the host vehicle M and the rear reference vehicle mC are both greater than respective thresholds, the behavior plan generation unit 140 determines that the lane change is possible. Such a determination condition is merely one example of the case in which the lane change target position TAs is set on the lateral side of the host vehicle M.

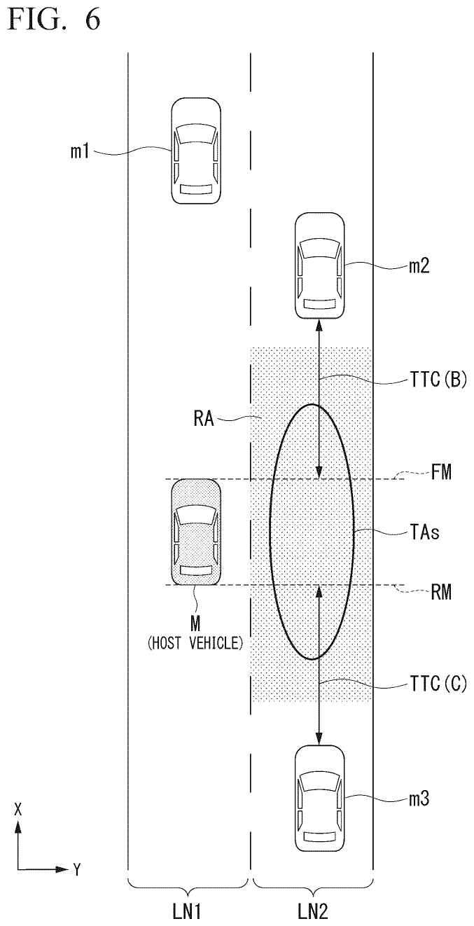

As illustrated in FIG. 6, for example, the behavior plan generation unit 140 projects the host vehicle M onto the lane LN2 that is a lane change destination and sets the prohibited region RA having certain safety margins in the front and rear. The prohibited region RA is set as a region extending from one edge to the other edge in a travel direction (Y direction) of the lane LN2.

When no other vehicle is present within the prohibited region RA, the behavior plan generation unit 140 sets, for example, virtual extension lines FM and RM from front and rear ends of the host vehicle M toward the lane LN2 that is a lane change destination. The behavior plan generation unit 140 calculates a time to collision TTC(B) between the extension line FM and the forward reference vehicle mB, and a time to collision TTC(C) between the extension line RM and the rear reference vehicle mC. The time to collision TTC(B) is a time derived by dividing a distance between the extension line FM and the forward reference vehicle mB (the other vehicle m2 in the illustrated example) by a relative speed of the host vehicle M and the forward reference vehicle mB. The time to collision TTC(C) is a time derived by dividing the distance between the extension line RM and the rear reference vehicle mC (the other vehicle m3 in the illustrated example) by a relative speed of the host vehicle M and the rear reference vehicle mC. The behavior plan generation unit 140 determines that the lane change is possible when both the time to collision TTC(B) is greater than a threshold Th(B) and the time to collision TTC(C) is greater than a threshold Th(C). The thresholds Th(B) and Th(C) may be the same value or may be different values.

When the behavior plan generation unit 140 determines that the lane change is not possible, the behavior plan generation unit 140 newly reselects two other vehicles from among the plurality of other vehicles traveling on the adjacent lane LN2 and resets the lane change target position TAs between the two newly selected vehicles. One of the two newly selected vehicles may be a previously selected vehicle.

The behavior plan generation unit 140 repeats the setting of the lane change target position TAs until the behavior plan generation unit 140 determines that the lane change is possible. In this case, the behavior plan generation unit 140 may generate a target trajectory in which the host vehicle M is caused to wait on the host lane LN1, or generate a target trajectory in which the host vehicle M is decelerated or accelerated to laterally move the host vehicle M toward the lane change target position TAs on the host lane LN1.

When the behavior plan generation unit 140 determines that the lane change is possible, the behavior plan generation unit 140 outputs information indicating the generated target trajectory to the second control unit 160.

The second control unit 160 controls the travel drive force output device 200, the brake device 210, and the steering device 220 so that the host vehicle M passes through the target trajectory generated by the behavior plan generation unit 140 at a scheduled time.

The second control unit 160 includes, for example, a first acquisition unit 162, a speed control unit 164, and a steering control unit 166. A combination of the behavior plan generation unit 140 and the second control unit 160 is an example of a “lane change control unit.”

The first acquisition unit 162 acquires information on the target trajectory (trajectory points) from the behavior plan generation unit 140 and stores the information in the memory of the storage unit 190.

The speed control unit 164 controls one or both of the travel drive force output device 200 and the brake device 210 based on the speed elements (for example, target speed or target acceleration) included in the target trajectory stored in the memory.

The steering control unit 166 controls the steering device 220 in accordance with the position element (for example, a curvature representing a degree of bending of the target trajectory) included in the target trajectory stored in the memory.

The processing of the speed control unit 164 and the steering control unit 166 is realized, for example, by a combination of feedforward control and feedback control. As one example, the steering control unit 166 executes a combination of feedforward control according to a curvature of a road ahead of the host vehicle M and feedback control based on a deviation from the target trajectory.

The travel drive force output device 200 outputs travel drive force (torque) for travel of the vehicle to drive wheels. The travel drive force output device 200 includes, for example, a combination of an internal combustion engine, an electric motor, and a transmission, and a power electronic control unit (ECU) that controls these components. The power ECU controls the above configuration according to information input from the second control unit 160 or information input from the driving operator 80.

The brake device 210 includes, for example, a brake caliper, a cylinder for transmitting hydraulic pressure to the brake caliper, an electric motor for generating hydraulic pressure in the cylinder, and a brake ECU. The brake ECU controls the electric motor according to the information input from the second control unit 160 or the information input from the driving operator 80, so that brake torque corresponding to a braking operation is output to each wheel. The brake device 210 may include, as a backup, a mechanism that transmits hydraulic pressure generated by operating the brake pedal included in the driving operator 80 to the cylinder via a master cylinder. The brake device 210 is not limited to the above configuration; and may also be an electronically controlled hydraulic brake device that controls an actuator according to the information input from the second control unit 160 to transmit the hydraulic pressure from the master cylinder to the cylinder.

The steering device 220 includes, for example, a steering ECU and an electric motor. The electric motor, for example, applies force to a rack-and-pinion mechanism to change directions of the steered wheels. The steering ECU drives the electric motor according to the information input from the second control unit 160 or the information input from the driving operator 80, thereby changing the directions of the steered wheels.

The third control unit 170 includes a second acquisition unit 172, a mode control unit 174, a first determination unit 176, a second determination unit 178, and a recommendation unit 180.

The second acquisition unit 172 acquires, for example, a recognition result from the recognition unit 130 or information input to the HMI 30 by the occupant. The second acquisition unit 172 provides various types of acquired information to the mode control unit 174, the first determination unit 176, and the second determination unit 178.

The mode control unit 174 controls the driving mode of the host vehicle M. Examples of the driving mode of the host vehicle M include a manual driving mode and an automated driving mode. The manual driving mode is a mode in which the speed and steering of the host vehicle M are controlled in response to the driving operation by the occupant.

The automated driving mode is a mode in which either the speed or the steering of the host vehicle M or both the speed and the steering of the host vehicle M are automatically controlled regardless of the driving operation by the occupant. The automated driving mode includes a plurality of automated driving modes such as a first automated driving mode, a second automated driving mode, a third automated driving mode, a fourth automated driving mode, and a fifth automated driving mode. These automated driving modes differ in levels of control automation. Further, under some of these automated driving modes, an obligation (also referred to as a “task”) corresponding to a level of control automation is imposed on the occupant of the host vehicle M.

The first automated driving mode is the automated driving mode with the lowest level of automation. Under the first automated driving mode, for example, driving assistance control such as adaptive cruise control (ACC) or lane keeping assist system (LKAS) is performed. Under the first automated driving mode, LKAS is limited while ACC is being performed, and ACC is limited while LKAS is being performed. In other words, under the first automated driving mode, steering control and speed control are processed sequentially. In the first automated driving mode, a first obligation and a second obligation are imposed on the occupant of the host vehicle M. The first obligation is an obligation to monitor surroundings (particularly the front) of the host vehicle M, and the second obligation is an obligation to operate the steering wheel. “Operate” may refer to grasping with the hand or touching with the hand.

The second automated driving mode is an automated driving mode with a higher level of automation than the first automated driving mode. Under the second automated driving mode, for example, a plurality of driving assistance controls such as ACC, LKAS, and auto lane changing (ALC) are performed in an interlinked manner. Under the second automated driving mode, a degree of obligation required of the occupant is the same as or lower than that under the first automated driving mode. For example, under the second automated driving mode, the first obligation is imposed on the occupant, but in principle, the second obligation is not imposed. Under the second automated driving mode, the second obligation may be additionally imposed on the occupant at a timing such as immediately before some driving assistance controls such as ALC is performed.

The third automated driving mode is an automated driving mode with a higher level of automation than the second automated driving mode. Under the third automated driving mode, both the speed and the steering of the host vehicle M are automatically controlled when specific conditions are satisfied. The specific conditions include, for example, that there are few obstacles and the host vehicle M is traveling on a road where the host vehicle M can recognize a host lane or recognize a relative position of the host vehicle M with respect to the host lane. Such a road is, for example, a highway. Under the third automated driving mode, a degree of obligation required of the occupant is lower than that under the second automated driving mode. For example, under the third automated driving mode, neither the first obligation nor the second obligation is imposed on the occupant. Under the third automated driving mode, the driving operation by the occupant may be required in an emergency or the like.

The fourth automated driving mode is an automated driving mode with the same or higher level of automation as the third automated driving mode. Under the fourth automated driving mode, both the speed and the steering of the host vehicle M are automatically controlled when specific conditions are satisfied. Under the fourth automated driving mode, the degree of obligation required of the occupant is lower than that under the second automated driving mode, similarly to the third automated driving mode. For example, under the fourth automated driving mode, neither the first obligation nor the second obligation is imposed on the occupant. Under the fourth automated driving mode, both the speed and steering of the host vehicle M are automatically controlled regardless of the driving operation by the occupant even in emergency or the like.

The fifth automated driving mode is an automated driving mode with the same or higher level of automation as the fourth automated driving mode. Under the fifth automated driving mode, both the speed and the steering of the host vehicle M are automatically controlled regardless of specific conditions. Under the fifth automated driving mode, the degree of obligation required of the occupant is lower than that under the second automated driving mode, similarly to the third or fourth automated driving mode. For example, under the fifth automated driving mode, neither the first obligation nor the second obligation is imposed on the occupant.

For example, when the host vehicle M in the second automated driving mode satisfies the specific conditions, the mode control unit 174 may switch the driving mode to an automated driving mode having a higher level of automation than the second automated driving mode (for example, the third automated driving mode).

Further, for example, when the host vehicle M in the third automated driving mode or the fourth automated driving mode does not satisfy the specific conditions, the mode control unit 174 may switch the driving mode to the second automated driving mode or the first automated driving mode. “Not satisfying the specific conditions” is, for example, the host vehicle M traveling on a road with more obstacles and a more complex surrounding environment than a highway, or on a road where lanes and the like cannot be recognized. Such roads are, for example, ordinary roads.

Further, the mode control unit 174 may control the driving mode of the host vehicle M based on determination results of the first determination unit 176 and the second determination unit 178, which will be described later.

Further, the mode control unit 174 may control the driving mode based on a detection signal output from the driving operator 80. For example, under the automated driving mode, when the occupant operates the steering wheel, the accelerator pedal, or the brake pedal with an operation amount exceeding a threshold, the mode control unit 174 may switch the driving mode to the manual driving mode.

Moreover, the mode control unit 174 may control the driving mode of the host vehicle M based on an input operation with respect to the HMI 30.

The first determination unit 176 analyzes an image generated by the in-vehicle camera 90 to detect a direction of a line of sight or a direction of a face of the occupant in the driver's seat under an automated driving mode in which the first obligation is imposed. Based on the detected direction of the line of sight or the face, the first determination unit 176 determines whether or not the occupant in the driver's seat is monitoring the surroundings of the host vehicle M. In other words, the first determination unit 176 determines whether or not the occupant is fulfilling the first obligation. For example, when the occupant is looking outside through the front windshield, the first determination unit 176 determines that the occupant is monitoring the surroundings of the host vehicle M. That is, the first determination unit 176 determines that the occupant is fulfilling the first obligation.

The second determination unit 178, under the automated driving mode in which the second obligation is imposed, determines whether the occupant is grasping or touching the steering wheel with the hand based on a detection result from the steering sensor. That is, the second determination unit 178 determines whether or not the occupant is fulfilling the second obligation. For example, when a current value or steering torque detected by the steering sensor is equal to or greater than a threshold, the second determination unit 178 determines that the occupant is grasping or touching the steering wheel with the hand. That is, the second determination unit 178 determines that the occupant is fulfilling the second obligation. Hereinafter, a state in which the occupant is fulfilling the second obligation, that is, the occupant is grasping the steering wheel may be referred to as “hands-on,” and a state in which the occupant is not fulfilling the second obligation, that is, the occupant is not grasping the steering wheel may be referred to as “hands-off.”

The recommendation unit 180 outputs an active lane change recommendation (hereinafter referred to as “ALCR”) to the occupant via the display device 32 (at least one of the first display 32A and the second display 32B) or a speaker of the HMI 30.

Specifically, when the behavior plan generation unit 140 determines that the lane change is necessary, the recommendation unit 180 outputs the ALCR under the second, third, fourth, or fifth automated driving mode (that is, under the automated driving mode in which auto lane changing can be executed).

The ALCR includes a weak recommendation and a strong recommendation. The weak recommendation is a recommendation not for recommending a lane change to the occupant, but merely for notifying the occupant that the lane change is possible under a current situation. The strong recommendation is a recommendation for recommending the lane change to the occupant. In other words, the strong recommendation is a recommendation for recommending the lane change to the occupant more strongly than the weak recommendation.

### Details of ALCR: Strong Recommendation

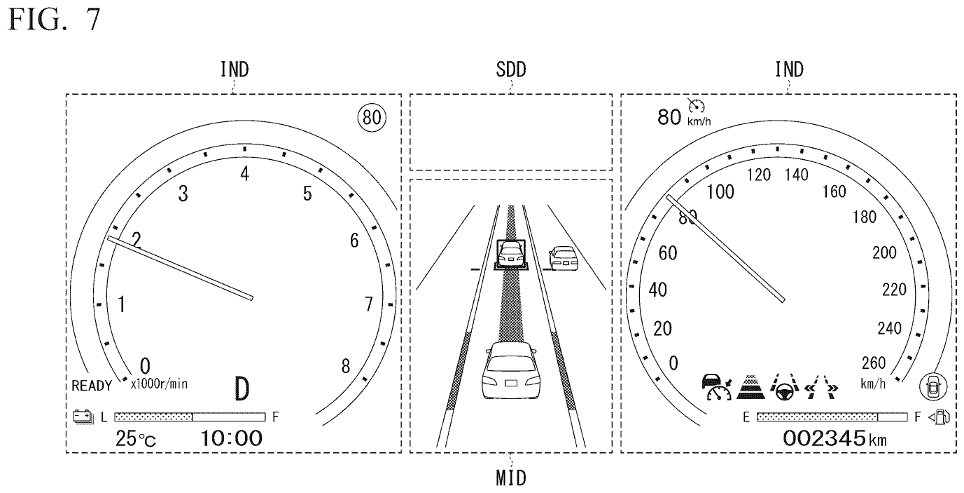

FIG. 7 is a diagram illustrating an example of display of the strong recommendation. The strong recommendation may be displayed on, for example, a first display 32A. The first display 32A includes a multi-information display (MID), an instrument navigation display (IND), and a symbol driver display (SDD). The first display 32A is an example of an “output interface”.

The MID is arranged at a center of a screen of the first display 32A. In the MID, surrounding circumstances of the host vehicle M for which a lane change is recommended is displayed. More specifically, a future trajectory (target trajectory) of the host vehicle M, presence or absence of the lane change, a lane that is a lane change destination, recognized lanes (lane markings), other vehicles, and the like are displayed in the MID as the surrounding circumstances. Further, information for guiding the occupant along the route to the destination determined by the navigation device 50 (hereinafter referred to as guidance information) is displayed as the strong recommendation in the MID.

The IND is arranged at a position offset from the center of the screen of the first display 32A (for example, on the right side and the left side of the MID). The speed of the host vehicle M, the engine speed, the remaining fuel amount, the radiator water temperature, the travel distance, the remaining battery amount, and the like are displayed in the IND. Further, in the IND, the guidance information also displayed in the MID may be displayed.

The SDD is arranged, for example, above the MID. In the SDD, information regarding the driving is displayed as a symbol (sign) or an icon or the information regarding the driving is displayed as messages.

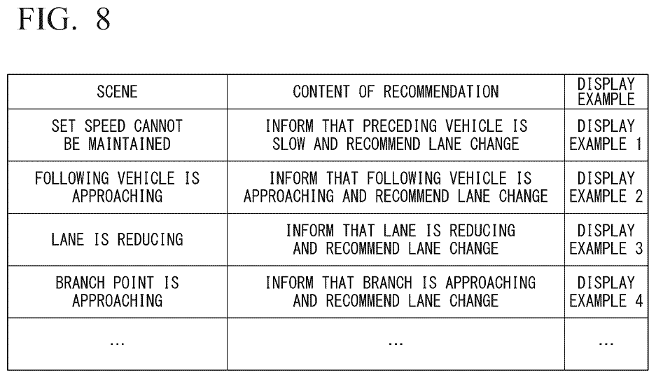

FIG. 8 is a diagram illustrating an example of classification of scenes in which the strong recommendation is output. For example, when the host vehicle M is set to travel at a constant speed, the strong recommendation may be output, for example, in a scene in which a speed of a preceding vehicle is low and a set speed of the host vehicle M cannot be maintained, a scene in which a following vehicle approaches, a scene in which the lane in which the host vehicle M is traveling disappears ahead in the traveling direction of the host vehicle M (that is, a number of lanes reduction scene), or a scene in which the host vehicle M is approaching a destination branch point.

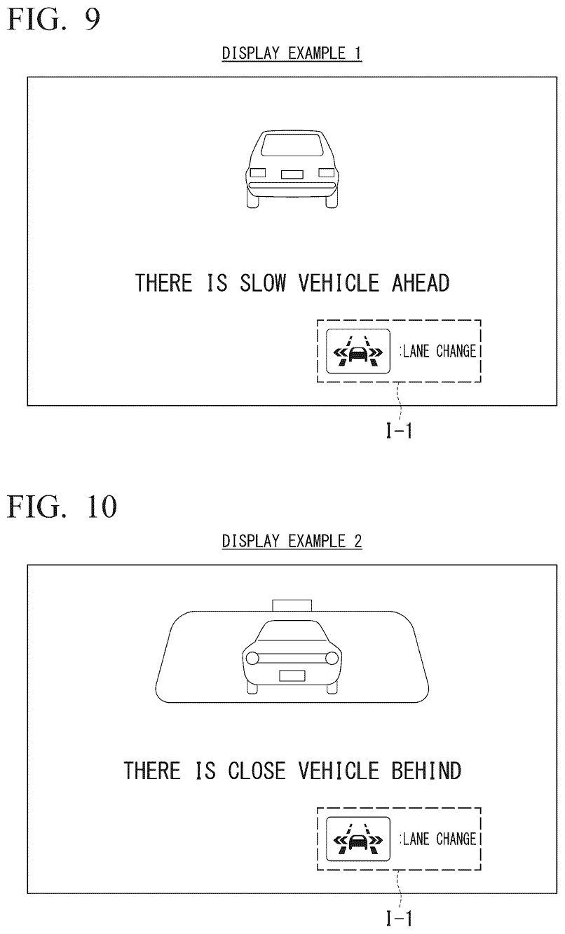

FIGS. 9 to 12 are diagrams illustrating an example of an image output in the MID as the strong recommendation in each scene. As illustrated in FIG. 9, in the scene in which the set speed cannot be maintained, an image representing the preceding vehicle may be displayed as the strong recommendation, or text indicating that the speed of the preceding vehicle is low may be displayed. Further, an icon I-1 indicating that the lane change is possible is also displayed.

As illustrated in FIG. 10, in the scene in which the following vehicle is approaching, an image representing the following vehicle may be displayed as the strong recommendation, text indicating that the following vehicle is approaching may be displayed, or the icon I-1 indicating that the lane change is possible may be displayed.

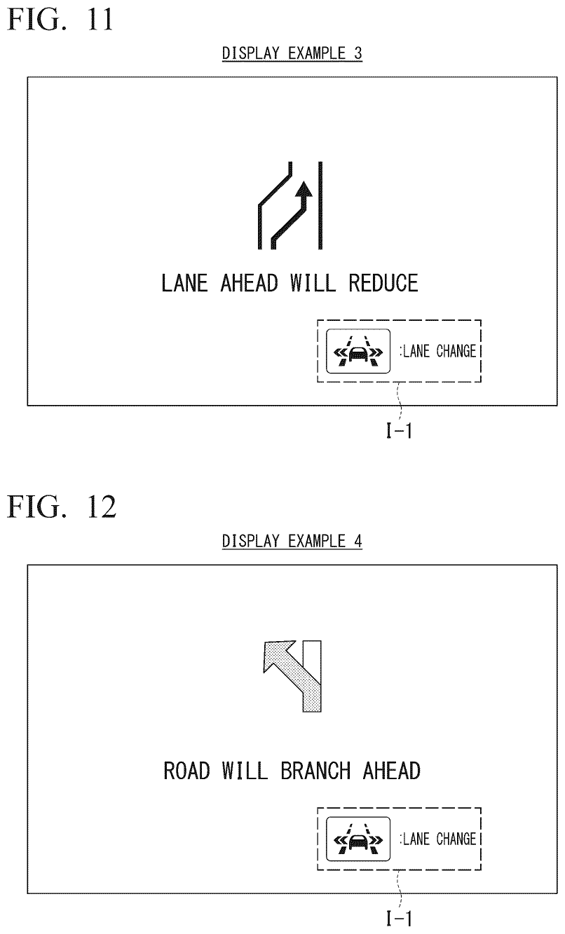

As illustrated in FIG. 11, in a scene in which the number of lanes reduces, an image or text indicating that the lane in which the host vehicle M is traveling disappears ahead in the direction in which the host vehicle M is traveling may be displayed as the strong recommendation, or the icon I-1 indicating that the lane change is possible may be displayed.

As illustrated in FIG. 12, in a scene in which the host vehicle M is approaching the destination branch point, an image or text indicating that the destination branch point is present ahead in the direction in which the host vehicle M travels may be displayed as the strong recommendation, or the icon I-1 indicating that the lane change is possible may be displayed.

The above-described icon I-1 may be displayed in the IND or the SDD instead of or in addition to the MID.

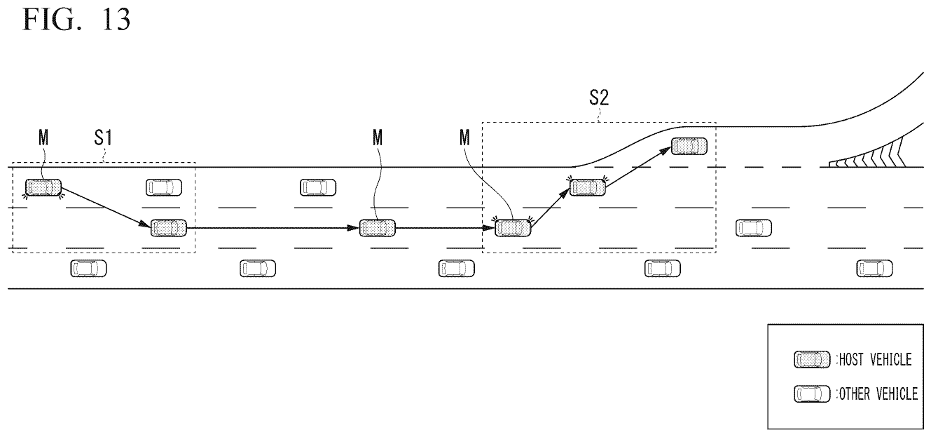

FIG. 13 schematically illustrates an example of a scene in which the strong recommendation is output. In a scene S1, a preceding vehicle is slow, and the host vehicle M cannot maintain its set speed due to deceleration. In such a scene S1, the strong recommendation as illustrated in FIG. 9 is output. In a scene S2, the host vehicle M is approaching the destination branch point. In such a scene S2, the strong recommendation as illustrated in FIG. 12 is output.

For example, when the occupant operates the ALCR switch 34A in response to the strong recommendation being output, the recommendation unit 180 determines that the lane change has been approved by the occupant. In this case, the recommendation unit 180 provides a determination result indicating that the lane change has been approved by the occupant to the behavior plan generation unit 140. The behavior plan generation unit 140 receives the determination result and generates the target trajectory in which the host vehicle M is caused to perform the lane change, and the second control unit 160 controls the steering and speed of the host vehicle M based on the target trajectory. Accordingly, auto lane changing is executed in the scene S1 or S2.

### Details of ALCR: Weak Recommendation

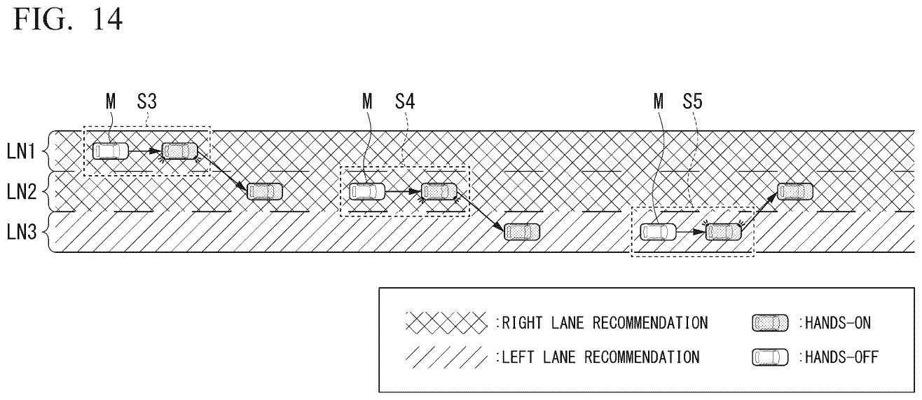

FIG. 14 schematically illustrates an example of a scene in which the weak recommendation is output. In scenes S3 to S5 illustrated in FIG. 14, there are no other vehicles around the host vehicle M, the number of lanes is not reduced, and no destination branch point is present nearby. In such scenes S3 to S5, since the host vehicle M can freely perform a lane change to another lane, the weak recommendation is output.

For example, when the host vehicle M is present in the leftmost lane LN1 as in the scene S3, a lane change to a center lane LN2 is recommended as the weak recommendation. When the host vehicle M is present in the center lane LN2 as in scene S4, a lane change to a rightmost lane LN3 (the overtaking lane) is recommended as the weak recommendation. When the host vehicle M is present in the rightmost lane LN3 as in scene S5, a lane change to the center lane LN2 is recommended as the weak recommendation.

For example, when the occupant operates the ALCR switch 34A in response to the weak recommendation being output, the recommendation unit 180 determines that the lane change has been approved by the occupant. In this case, the recommendation unit 180 provides to the behavior plan generation unit 140 the determination result indicating that the lane change has been approved by the occupant. The behavior plan generation unit 140 receives the determination result and generates the target trajectory in which the host vehicle M is caused to perform the lane change, and the second control unit 160 controls the steering and speed of the host vehicle M based on the target trajectory. Accordingly, the auto lane changing is executed in the scenes S3 to S5.

As described above, under the second automated driving mode, the second obligation may be imposed on the occupant immediately before the auto lane changing is executed. In such a case, if the occupant has fulfilled the second obligation, that is, has hands-on control when the weak recommendation is output and the ALCR switch 34A is operated, the auto lane changing is executed.

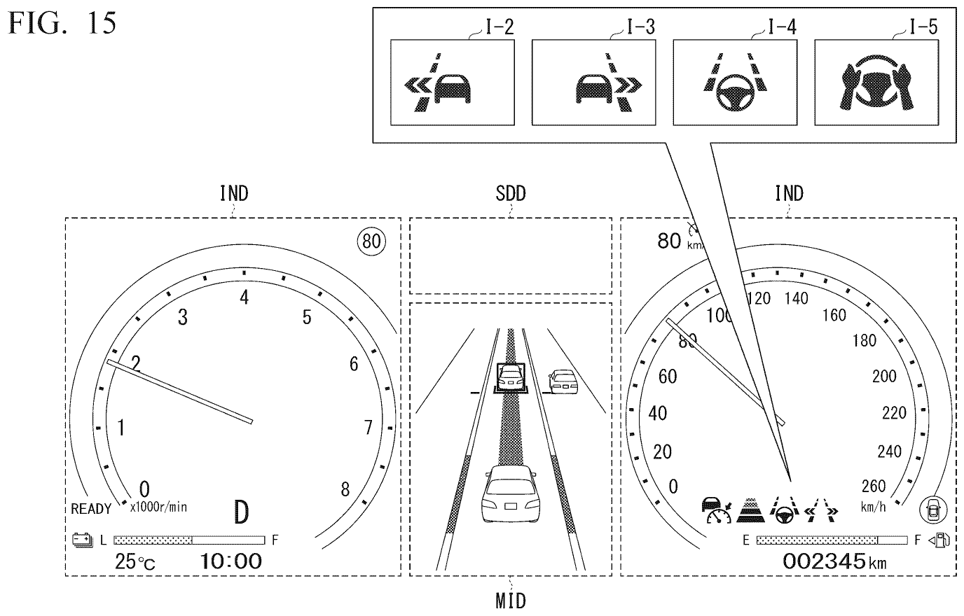

FIG. 15 is a diagram illustrating an example of the display of the weak recommendation. The weak recommendation may also be displayed on the first display 32A, similarly to the strong recommendation. For example, an icon I-2 representing a recommendation for a lane change to a left lane and an icon I-3 representing a recommendation for a lane change to a right lane may be displayed as the weak recommendation in the IND of the first display 32A.

Further, in the IND, an icon I-4, an icon I-5, or the like may be displayed before the ALCR is displayed, that is, under the first automated driving mode in which auto lane changing is not executed. The icon I-4 is an icon for prompting the occupant to operate the ALCR switch 34A under the first automated driving mode. That is, the icon I-4 is an icon for prompting the occupant to transition to an activated state in which the ALC is executable. The icon I-5 is an icon for requesting hands-on control from the occupant. As described above, immediately before the auto lane changing is executed under the second automated driving mode, the second obligation (hands-on) may be imposed on the occupant, and the icon I-5 is displayed to request the occupant to fulfill the second obligation (hands-on).

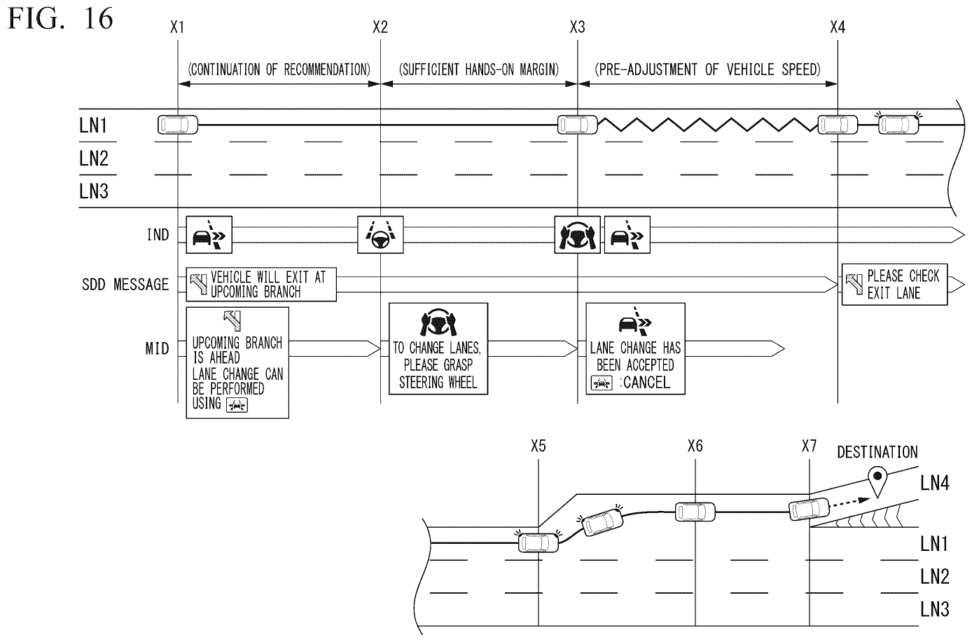

FIG. 16 is a diagram showing an example of driving control of the host vehicle M and a display of the first display 32A. In the diagram, X1 is a recommendation start point, X2 is a recommendation end point, and X3 is a pre-vehicle-speed adjustment start point. X4 is a lane change start point, X5 is a branch start point, X6 is a lane change end point, and X7 is a branch end point. The recommendation start point X1 is an example of a “predetermined point”, and the branch start point X5 is an example of a “route guidance point”.

The recommendation start point X1 is a point determined to start outputting the ALCR, and is provided upstream of the branch start point X5.

The recommendation end point X2 is a point determined to end outputting the ALCR, is beyond the recommendation start point X1, and is provided upstream of the branch start point X5.

The pre-vehicle-speed adjustment start point X3 is a point determined to adjust the speed of the host vehicle M to a speed suitable for the lane change recommended as the ALCR, is beyond the recommendation end point X2, and is provided upstream of the branch start point X5.

The lane change start point X4 is a point at which the lane change recommended as the ALCR is started, is beyond the pre-vehicle-speed adjustment start point X3, and is provided upstream of the branch start point X5.

The branch start point X5 is a point at which lanes start to branch on an expressway. In the present embodiment, description is made assuming that a destination exists ahead of a branch road LN4 and the host vehicle M changes lanes from a first lane LN1 of a main line to the branch road LN4 on the expressway. The branch road LN4 is an example of a “target lane”.

The lane change end point X6 is a point at which the lane change recommended as the ALCR is ended.

The branch end point X7 is a point at which branching of lanes ends on the expressway.

For example, the recommendation unit 180 assumes that, in a period until the host vehicle M reaches the recommendation start point X1, the occupant operates the ALCR switch 34A for transition from a non-activated state to an activated state. That is, it is assumed that transition has occurred from the first automated driving mode to the second automated driving mode. When the host vehicle M reaches the recommendation start point X1 in the activated state, the recommendation unit 180 starts outputting the ALCR (the weak recommendation and the strong recommendation).

For example, when the host vehicle M reaches the recommendation start point X1 in the activated state, the recommendation unit 180 causes the weak recommendation to be displayed in the IND of the first display 32A and causes the strong recommendation to be displayed in the MID of the first display 32A.

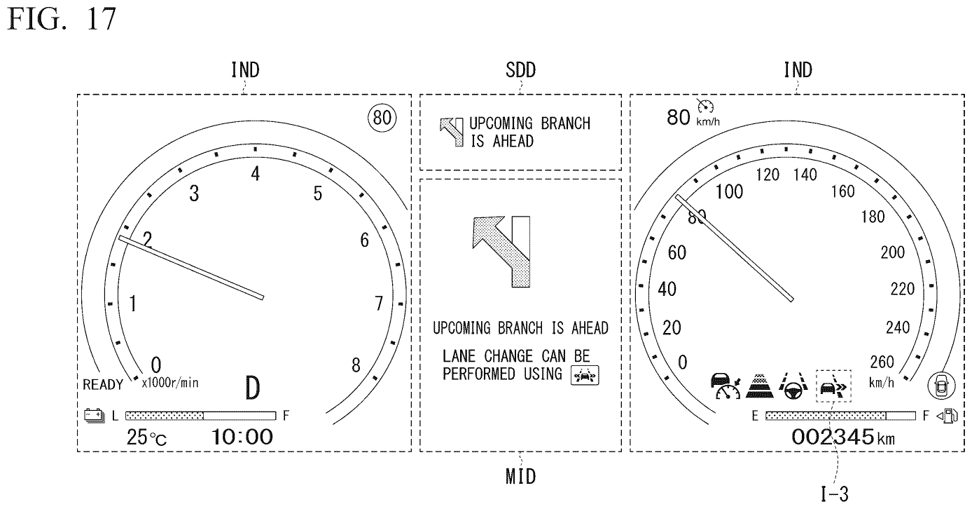

FIG. 17 is a diagram showing an example of the screen of the first display 32A when the host vehicle M has reached the recommendation start point X1 in the activated state. When the host vehicle M has reached the recommendation start point X1 in the activated state, the icon I-3 representing the recommendation of the lane change to the right lane is displayed as the weak recommendation in the IND of the first display 32A, and an icon or a message for guiding the host vehicle M to the branch road LN4 at the branch start point X5 is displayed as the strong recommendation in the MID and the SDD.

The recommendation unit 180 causes the icon I-4 for prompting the occupant to operate the ALCR switch 34A to be displayed in the IND in a period from the host vehicle M passing through the recommendation start point X1 to the host vehicle M reaching the recommendation end point X2, and ends outputting the ALCR (the weak recommendation and the strong recommendation) when the host vehicle M reaches the recommendation end point X2. The recommendation unit 180 may continue outputting the weak recommendation even when the host vehicle M reaches the recommendation end point X2.

For example, it is assumed that, in the period from the host vehicle M passing through the recommendation start point X1 to the host vehicle M reaching the recommendation end point X2, the occupant operates the ALCR switch 34A. That is, it is assumed that the occupant approves the lane change recommended as the ALCR.

In this case, the recommendation unit 180 causes the first display 32A to display an icon or a message for requesting the occupant to fulfill the second obligation (hands-on).

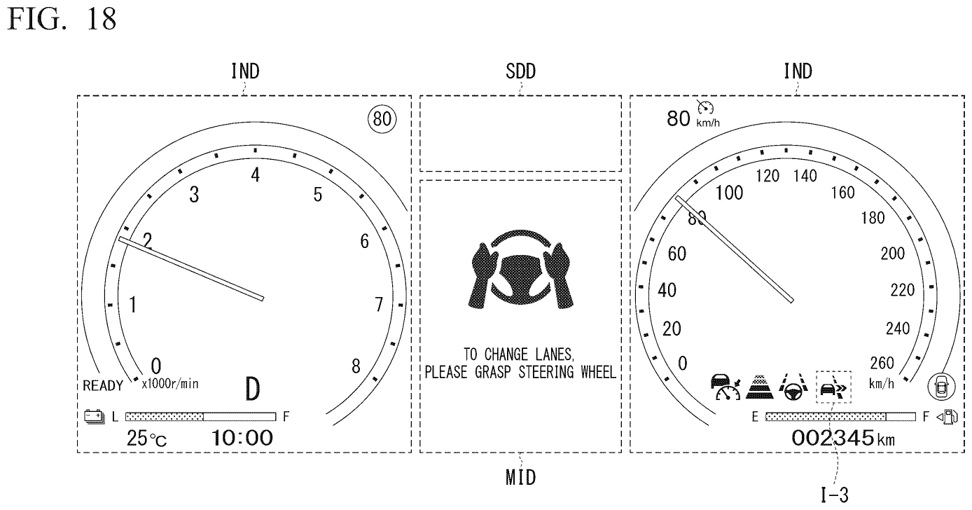

FIG. 18 is a diagram showing an example of the screen of the first display 32A when the occupant approves the lane change. When the occupant approves the lane change, an icon or a message representing hands-on may be displayed in the MID as shown.

When the host vehicle M reaches the pre-vehicle-speed adjustment start point X3 after the occupant approves the lane change, the behavior plan generation unit 140 generates a target trajectory for adjusting the speed of the host vehicle M, and the second control unit 160 controls the speed of the host vehicle M based on the target trajectory. In this case, the recommendation unit 180 may cause the first display 32A to display an icon or a message indicating that the lane change approved by the occupant has been accepted by the automated driving control device 100.

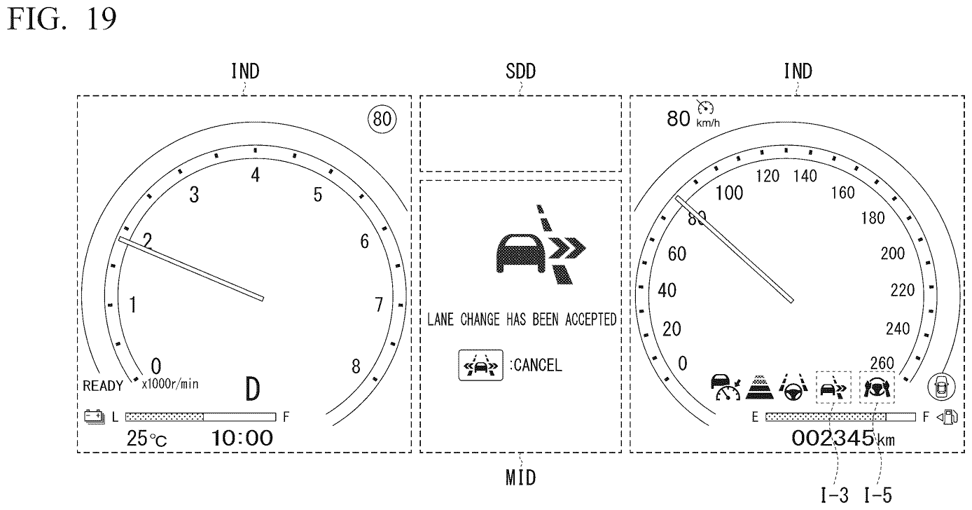

FIG. 19 is a diagram showing an example of the screen of the first display 32A in a hands-on state. When the occupant grasps the steering wheel after approving the lane change (the hands-on state), the icon or the message indicating that the lane change approved by the occupant has been accepted by the automated driving control device 100 is displayed in the MID, as shown. When the occupant operates the ALCR switch 34A again after the lane change approved by the occupant has been accepted, the approval can be canceled.

When the host vehicle M reaches the lane change start point X4 after the speed of the host vehicle M is adjusted, the behavior plan generation unit 140 generates a target trajectory in which the host vehicle M is caused to change lanes, and the second control unit 160 controls steering and speed of the host vehicle M based on the target trajectory. Accordingly, the host vehicle M changes lanes to the branch road LN4 at the branch start point X5.

### Processing Flow

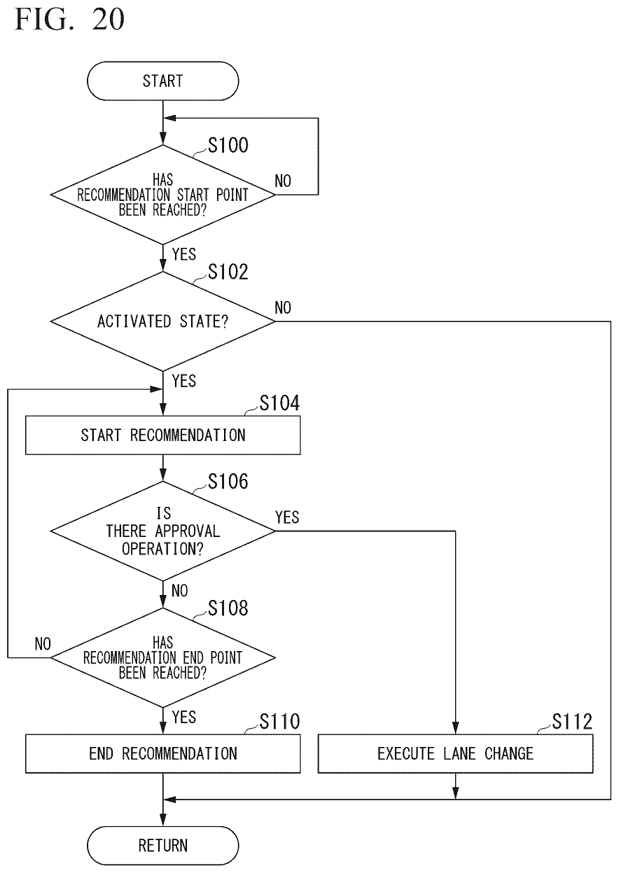

Hereinafter, a flow of a series of processing in the automated driving control device 100 of the embodiment will be described using a flowchart. FIG. 20 is a flowchart showing an example of the flow of the series of processing in the automated driving control device 100 of the embodiment. The processing of the present flowchart may be repeatedly executed at a predetermined cycle, for example, when a vehicle travels on the expressway.

First, the recommendation unit 180 waits until the host vehicle M reaches the recommendation start point X1 (step S100), and determines whether in the activated state when the host vehicle M reaches the recommendation start point X1 (step S102). That is, the recommendation unit 180 determines whether the ALCR switch 34A has been operated before the host vehicle M reaches the recommendation start point X1.

When not in the activated state, that is, when the ALCR switch 34A has not been operated before the host vehicle M reaches the recommendation start point X1, the recommendation unit 180 ends the processing of the present flowchart without outputting the ALCR.

On the other hand, when in the activated state, that is, when the ALCR switch 34A has been operated before the host vehicle M reaches the recommendation start point X1, the recommendation unit 180 starts outputting the ALCR (step S104).

Next, the recommendation unit 180 determines whether the ALCR switch 34A has been operated after the ALCR is output (step S106). That is, the recommendation unit 180 determines whether there has been the approval operation after the ALCR is output.

When there is no approval operation, the recommendation unit 180 determines whether the host vehicle M has reached the recommendation end point X2 (step S108). When there is no approval operation and the host vehicle M has not reached the recommendation end point X2, the recommendation unit 180 returns the processing to S104 and continues outputting the ALCR.

When there is no approval operation in a period until the host vehicle M reaches the recommendation end point X2, the recommendation unit 180 ends outputting the ALCR (step S110).

It is also assumed that, in the period until the host vehicle M reaches the recommendation end point X2, the occupant operates the ALCR switch 34A to cause transition to occur from the non-activated state to the activated state. Even in such a case, the recommendation unit 180 does not start outputting the ALCR.

On the other hand, when there is the approval operation in the period until the host vehicle M reaches the recommendation end point X2, the behavior plan generation unit 140 generates the target trajectory in which the host vehicle M is caused to change lanes, and the second control unit 160 controls the steering and speed of the host vehicle M based on the target trajectory. Accordingly, the lane change recommended as the ALCR is executed.

According to the embodiment described above, in the activated state in which the ALC is executable, when the host vehicle M has reached the recommendation start point X1 (an example of a “predetermined point”) upstream of the branch start point X5 (an example of the “route guidance point”), the automated driving control device 100 starts outputting the ALCR via the first display 32A (an example of an “output interface”). When the approval operation is input to the ALCR switch 34A (an example of an “input interface”) after the output of the ALCR is started, the automated driving control device 100 executes the lane change recommended as the ALCR. When the occupant operates the ALCR switch 34A to cause transition to occur from the non-activated state to the activated state after the host vehicle M passes through the branch start point X5, the automated driving control device 100 does not start outputting the ALCR.

Thus, when, after the host vehicle M passes through the recommendation start point X1 at which the output of the ALCR is started, the occupant operates the ALCR switch 34A to cause transition to occur from the non-activated state to the activated state, the output of the ALCR is not started. As a result, withdrawal of the ALCR immediately after the ALCR is output can be suppressed, and a feeling of discomfort of the occupant during execution of the lane change can be reduced.

### Other Embodiments

Hereinafter, other embodiments will be described. In the above-described embodiment, description has been made assuming that, in the second automated driving mode, the second obligation is imposed on the occupant immediately before the auto lane changing is executed, but the present disclosure is not limited thereto. For example, in the second automated driving mode, when the auto lane changing is executed, the second obligation may not be imposed on the occupant. In this case, when there is the approval operation from the occupant after the ALCR is output, the lane change is executed without hands-on.

Further, in the above-described embodiment, description has been made assuming that the output of the ALCR is controlled in a scene in which the host vehicle M is traveling in the first lane LN1 of the expressway, but the present disclosure is not limited thereto.

For example, the output of the ALCR is controlled also in a scene in which the host vehicle M is traveling in the second lane LN2, the third lane LN3, or the like of the expressway.

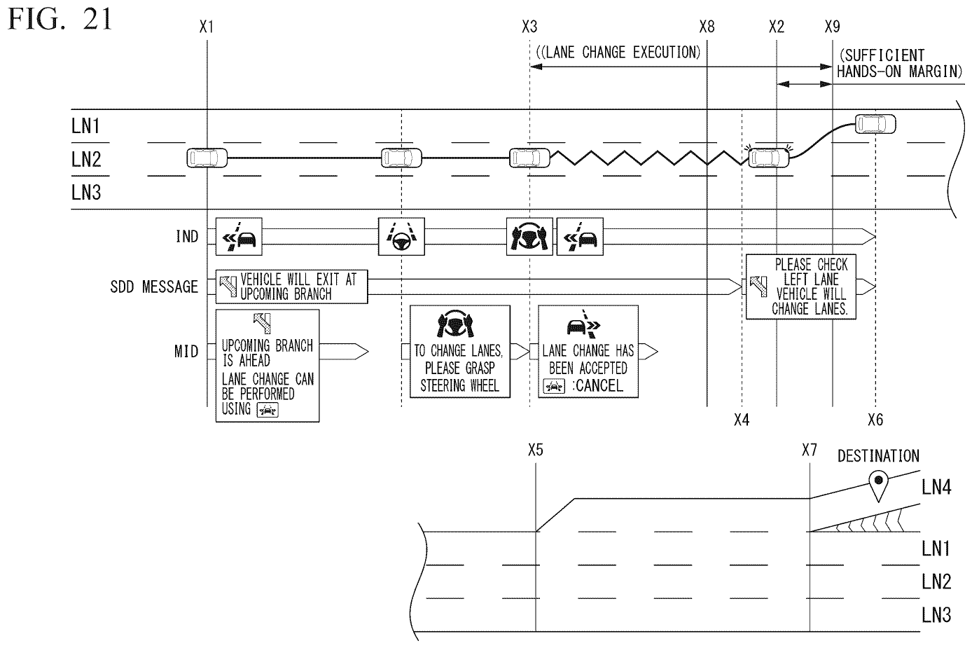

FIG. 21 is a diagram showing another example of driving control of the host vehicle M and the display of the first display 32A. In the illustrated scene, the host vehicle M is traveling in the second lane LN2. In such a scene, a recommendation start limit point X8 and a give-up point X9 may further be provided in addition to the several points X1 to X7 described above.

The recommendation start limit point X8 is a limit point for starting the output of the ALCR, is beyond the recommendation start point X1, and is provided upstream of the branch start point X5. Further, the recommendation start limit point X8 may be beyond the recommendation start point X1 and upstream of the recommendation end point X2. The recommendation start limit point X8 may be set not only in a scene as illustrated in FIG. 21 in which the host vehicle M is traveling in the second lane LN2, but also in a scene as illustrated in FIG. 16 in which the host vehicle M is traveling in the first lane LN1.

The give-up point X9 is a point at which execution of the lane change is canceled (given up) by the automated driving control device 100.

For example, the recommendation unit 180 may start outputting the ALCR when transition from the non-activated state to the activated state occurs in a period from the host vehicle M passing through the recommendation start point X1 to the host vehicle M reaching the recommendation start limit point X8. That is, even after the host vehicle M passes through the recommendation start point X1, the recommendation unit 180 may exceptionally start outputting the ALCR.

When the transition from the non-activated state to the activated state has occurred after the host vehicle M has reached the recommendation start limit point X8, the recommendation unit 180 does not start outputting the ALCR. Also, when the host vehicle M does not reach the branch start point X5 or the recommendation end point X2 even after the host vehicle M has reached the recommendation start limit point X8, the recommendation unit 180 may output the weak recommendation.

Thus, when the host vehicle M is traveling in the first lane LN1 adjacent to the branch road LN4 (an example of the “target lane”) at the branch start point X5, the recommendation unit 180 does not start outputting the ALCR even when the transition to the activated state occurs after the host vehicle M passes through the recommendation start point X1. On the other hand, when the host vehicle M is traveling in a lane (for example, the second lane LN2 or the third lane LN3) that is not adjacent to the branch road LN4 and is two or more lanes away from the branch road LN4 at the branch start point X5, the recommendation unit 180 starts outputting the ALCR even when the transition to the activated state occurs after the host vehicle M passes through the recommendation start point X1, as long as the host vehicle M does not reach the recommendation start limit point X8.

If there is sufficient margin for approval or start of the lane change even when the ALCR is output with such a delay, the output of the ALCR can be started after the host vehicle M passes through the recommendation start point X1.

Also, the recommendation start point X1 described in the above-described embodiment may be set as a different point between a case in which the host vehicle M is traveling in the first lane LN1 adjacent to the branch road LN4 (an example of a “target lane”) at the branch start point X5 and a case in which the host vehicle M is traveling in the lane (for example, the second lane LN2 or the third lane LN3) that is not adjacent to the branch road LN4 and is two or more lanes away from the branch road LN4.

For example, the recommendation start point X1 when the host vehicle M is traveling in the second lane LN2 or the third lane LN3 may be set farther from the branch start point X5 than the recommendation start point X1 when the host vehicle M is traveling in the first lane LN1. That is, the recommendation start point X1 when the host vehicle M is traveling in the second lane LN2 or the third lane LN3 may be set upstream of the branch start point X5 compared to the recommendation start point X1 when the host vehicle M is traveling in the first lane LN1.

Also, the recommendation start limit point X8 described in the above-described embodiment may be set as a different point between a case in which the hands-on is required (when the second obligation is imposed) and a case in which the hands-on is not required (when the second obligation is not imposed) during the lane change.

Although embodiments for carrying out the present invention have been described above, the present invention is not limited in any way to such embodiments, and various modifications and substitutions can be made without departing from the gist of the present invention.

What is claimed is:

1. A travel control device comprising:
an output interface configured to output information;
an input interface operated by an occupant of a vehicle;
a lane change control unit configured to cause transition to an activated state or a non-activated state to occur in response to an operation of the input interface by the occupant, and execute a lane change in the activated state; and
a recommendation unit configured to start outputting, via the output interface, a recommendation of a lane change to the occupant when the vehicle has reached a predetermined point upstream of a route guidance point in the activated state,
wherein the lane change control unit executes the lane change when an approval operation that is an operation by the occupant for approving the recommendation is input to the input interface after the output of the recommendation has been started, and
the recommendation unit does not start outputting the recommendation when the transition from the non-activated state to the activated state has occurred after the vehicle passes through the predetermined point.

2. The travel control device according to claim 1, wherein the recommendation unit
ends outputting the recommendation when the vehicle has reached a recommendation end point that is a point at which the output of the recommendation is ended without the approval operation being input to the input interface after the output of the recommendation has been started, the recommendation end point being beyond the predetermined point and upstream of the route guidance point; and
does not start outputting the recommendation when the transition from the non-activated state to the activated state has occurred in a period from the vehicle passing through the predetermined point to the vehicle reaching the recommendation end point.

3. The travel control device according to claim 1,
wherein the recommendation unit
starts outputting the recommendation when the transition from the non-activated state to the activated state has occurred in a period from the vehicle passing through the predetermined point to the vehicle reaching a recommendation start limit point, the recommendation start limit point being a limit point at which output of the recommendation is started, being beyond the predetermined point, and being upstream of the route guidance point; and
does not start outputting the recommendation when the transition from the non-activated state to the activated state has occurred after the vehicle has reached the recommendation start limit point.

4. The travel control device according to claim 2, wherein the recommendation unit
starts outputting the recommendation when the transition from the non-activated state to the activated state has occurred in a period from the vehicle passing through the predetermined point to the vehicle reaching a recommendation start limit point, the recommendation start limit point being a limit point at which output of the recommendation is started, being beyond the predetermined point, and being upstream of the recommendation end point; and
does not start outputting the recommendation when the transition from the non-activated state to the activated state has occurred after the vehicle has reached the recommendation start limit point.

5. The travel control device according to claim 1, wherein the recommendation unit
does not start outputting the recommendation when the transition from the non-activated state to the activated state has occurred after the vehicle passes through the predetermined point in a case in which the vehicle is traveling in a first lane adjacent to a target lane at the route guidance point;
starts outputting the recommendation when the transition from the non-activated state to the activated state has occurred, in a period from the vehicle passing through the predetermined point to the vehicle reaching a recommendation start limit point, the recommendation start limit point being a limit point at which output of the recommendation is started, being beyond the predetermined point, and being upstream of the route guidance point, in a case in which the vehicle is traveling in a second lane that is not adjacent to the target lane and is two or more lanes away at the route guidance point; and
does not start outputting the recommendation when the transition from the non-activated state to the activated state has occurred after the vehicle passes through the recommendation start limit point in a case in which the vehicle is traveling in the second lane.

6. The travel control device according to claim 5,
wherein the predetermined point is set as a different point between a case in which the vehicle is traveling in the first lane adjacent to the target lane at the route guidance point and a case in which the vehicle is traveling in the second lane that is not adjacent to the target lane and is two or more lanes away at the route guidance point, and
a second predetermined point that is the predetermined point set in the case in which the vehicle is traveling in the second lane is farther from the route guidance point than a first predetermined point that is the predetermined point set in the case in which the vehicle is traveling in the first lane.

7. The travel control device according to claim 5,
wherein the recommendation unit
ends outputting the recommendation when the vehicle has reached a recommendation end point that is a point at which the output of the recommendation is ended without the approval operation being input to the input interface after the output of the recommendation has been started, the recommendation end point being beyond the predetermined point and upstream of the route guidance point; and
does not start outputting the recommendation when the transition from the non-activated state to the activated state has occurred in a period from the vehicle passing through the predetermined point to the vehicle reaching the recommendation end point.

8. The travel control device according to claim 5, wherein the recommendation unit
starts outputting the recommendation when the transition from the non-activated state to the activated state has occurred in a period from the vehicle passing through the predetermined point to the vehicle reaching the recommendation start limit point; and
does not start outputting the recommendation when the transition from the non-activated state to the activated state has occurred after the vehicle has reached the recommendation start limit point.

9. The travel control device according to claim 3,
wherein the lane change executed when the approval operation is input to the input interface includes a first lane change requiring grasping of a steering wheel by the occupant and a second lane change not requiring grasping of the steering wheel by the occupant, and
the recommendation start limit point is set as a different point between a case in which the first lane change is executed and a case in which the second lane change is executed.

10. A travel control method using a computer mounted on a vehicle including an output interface configured to output information and an input interface operated by an occupant of the vehicle, the travel control method comprising:
causing transition to an activated state or a non-activated state to occur in response to an operation of the input interface by the occupant, and executing a lane change in the activated state;
starting outputting, via the output interface, a recommendation of a lane change to the occupant when the vehicle has reached a predetermined point upstream of a route guidance point in the activated state,
executing the lane change when an approval operation that is an operation by the occupant for approving the recommendation is input to the input interface after the output of the recommendation has been started; and
not starting outputting the recommendation when the transition from the non-activated state to the activated state has occurred after the vehicle passes through the predetermined point.

11. A non-transitory storage medium storing a program executed by a computer mounted on a vehicle including an output interface configured to output information and an input interface operated by an occupant of the vehicle, the program comprising:
causing transition to an activated state or a non-activated state to occur in response to an operation of the input interface by the occupant, and executing a lane change in the activated state;
starting outputting, via the output interface, a recommendation of a lane change to the occupant when the vehicle has reached a predetermined point upstream of a route guidance point in the activated state,
executing the lane change when an approval operation that is an operation by the occupant for approving the recommendation is input to the input interface after the output of the recommendation has been started; and
not starting outputting the recommendation when the transition from the non-activated state to the activated state has occurred after the vehicle passes through the predetermined point.
